(19) United States
(12) Patent Application Publication
(10) Pub. No.: US 2025/0171168 A1
(43) Pub. Date: May 29, 2025

(54) METHOD AND SYSTEM FOR NETWORK DATA COLLECTION, ANALYSIS, CONTROL, AND SELF-OPTIMIZATION OF A CLOSED ECOLOGICAL SYSTEM

(71) Applicant: United States of America as Represented by the Administrator of NASA, Washington, DC (US)

(72) Inventor: Gregory Allen DORAIS, San Jose, CA (US)

(21) Appl. No.: 17/110,287

(22) Filed: Dec. 3, 2020

Related U.S. Application Data
(60) Provisional application No. 62/935,511, filed on Nov. 14, 2019.

(51) Int. Cl. B64G 99/00; G06N 3/12

(52) U.S. Cl. CPC B64G 99/00; G05B 13/048; G16Z 99/00; G06N 3/12

(57) ABSTRACT

In one embodiment, a controlled closed-ecosystem development system (CCEDS) includes one or more a closed ecological systems (CESs) each having one or more controlled ecosystem modules (CESMs). Each CESM can have a biome containing at least one organism, and equipment comprising one or more of sensors, actuators, or components that are associated with the biome. A controller operates the equipment to effect transfer of material among CESMs to optimize one or more of organism variety, size, population, capacity, or sustainability of a biome of at least one CESM.

### CROSS-REFERENCE TO RELATED APPLICATIONS

This application claims benefit under 35 U.S.C. §§ 119 and 120 and 37 CFR1.78 (a) of U.S. Provisional Patent App. No. 62/935,511 filed on Nov. 14, 2019, the contents of which are incorporated herein by reference in their entirety.

### ORIGIN OF THE INVENTION

The invention described herein was made by (an) employee(s) of the United States Government and may be manufactured and used by or for the Government of the United States of America for governmental purposes without the payment of any royalties thereon or therefor.

### TECHNICAL FIELD

The present disclosure relates generally to controlled ecosystems, and more particularly, to a controlled closed-ecosystem development system (CCEDS) that can be used to develop designs for sustainable, small-scale reproductions of subsets of the Earth's biosphere.

### BACKGROUND

The Earth's biosphere is the most sophisticated complex adaptive system known to exist in the entire universe and has persisted for over 4 billion years. A complex adaptive system is a network of interacting adaptive systems whose nonlinear dynamics and emergent behaviors are difficult to predict and control; therefore for such systems, past performance is no guarantee of future results, which is particularly the case for the Earth's biosphere during a period of exponential technological growth. The scientific study of the Earth's biosphere traces back to Vladimir Vernadsky and his work “The Biosphere,” in which among other things, he made the case that life continuously transforms the geochemistry of the planet and in turn is so transformed.

It is desirable to develop designs for sustainable, small-scale reproductions of subsets of the Earth's biosphere that can be distributed both on and beyond Earth, for improving the quality of life for all life, expanding the diversity of life, studying and protecting life, as well as enabling life to permanently extend beyond Earth. Although the minimum size of a Closed EcoSystem (CES) that reliably persists indefinitely is unknown, a preeminent, long-term goal is to develop CESs that enable human populations to persist indefinitely independent of their locations on Earth and beyond. It is desirable to test the hypothesis of whether small, completely-independent reproductions of subsets of the Earth's biosphere, containing populations of microbes, plants, animals, and eventually people, thrive indefinitely, and to increase our understanding of the ecosystems we live in so they can be more verdant, diverse, and effectively managed.

A CES is a community of organisms and their resources that persist in a sealed volume such that mass is not added or removed. The effects of radiation on a CES can be considerable, but the minute amounts of CES mass added or removed due to radiation do not disqualify a sealed volume from being a CES. The mass (food/air/water) required by the CES organisms is continually recycled from the mass (waste) produced by the organisms. Energy and information may be transferred to and from a CES. CESs that can support mammals indefinitely remain speculative (other than the Earth itself, which is only partially closed). The combinations of minimum required mass, volume, and species (recipes) for mammalian CESs are unknown, but are expected to be miniscule compared to the Earth.

A Partially Closed EcoSystem (PCES) permits the limited addition and removal of mass. The extent to which an ecosystem is partially closed can run the gamut from being almost entirely closed, e.g., permitting medication and extracting organic samples, to being almost entirely open where CES mass addition and mass removal events are significant, frequent, and uncontrolled.

As depicted in FIG. 1, a human-occupied controlled CES would not require external sources of air, water, and food nor would it release any waste. Although efforts continue to be made toward this end, significant challenges remain. For NASA, progress must be made to reach the CES level of capability that is nearly essential to achieve U.S. Space Policy Directive 1, which directs the NASA Administrator to “enable human expansion across the solar system” (Federal Register, 2017), due to the vast distances involved among other things.

A CES can function with a wide range of species. Shown in FIG. 2 is an example of a CES that is partially terrestrial and partially aquatic. Phytoplankton, such as algae and cyanobacteria, use light, carbon dioxide, water, and other organic compounds to grow and reproduce, releasing oxygen in the process. Zooplankton, such as krill, consume phytoplankton, oxygen, and other resources to grow and reproduce, releasing carbon dioxide and wastes in the process. As zooplankton produce waste and eventually die, decomposing fungi and bacteria convert their remains and wastes to carbon dioxide and organic compounds, closing the resource loops. Fish can be added that feed on phytoplankton, zooplankton, and other fish. Rodents can be added that feed on fish; and weasels can be added that feed on fish and rodents, also closing resource loops as depicted in FIG. 2.

CESs instantiate small, controlled-biomes and their environments. F. Clements and V. Shelford first defined the term “biome” essentially as a biotic community of plants and animals populating a region. They stated, “From the beginnings of life, organisms have lived together in some kind of grouping . . . We know now that there are no habitats in which both plant and animal organisms are able to live, in which both do not occur and influence each other.” (Clements and Shelford, 1936, p. v).

Throughout the world, similar plants and animals group together. In Communities and Ecosystems (Whittaker, 1975), R. Whittaker characterized several biomes, with respect to the mean temperature and mean precipitation, and summarized this analysis in a diagram of terrestrial biomes. A simplified version of Whittaker's diagram is shown in FIG. 3.

The mean temperature and mean precipitation used by Whittaker in his analyses assumes that the Earth's day-night cycles and annual season cycles regularly occur. CESs have the capability to create small biomes with the same mean temperature and mean precipitation, but could have drastically different results. Consider a biome where the mean annual temperature is 10° C. and the mean annual precipitation is 150 cm, as is the case for Temperate Forests shown in FIG. 3, but the temperature is either above 100° C. or below 0° C. each day and all the rain falls only on one day a year. Such a biome would not foster life found in Temperate Forests. CESs enable the thorough study of such effects. This is of particular interest as scientists attempt to predict the potential impact of climate change and enable life beyond Earth among other things.

Each biome on Earth can be viewed as loosely-connected PCESs. Mountains and bodies of water may mark natural boundaries between terrestrial biomes, but organisms and resources can pass between these biomes. The temperature and precipitation levels associated with each biome define its effective region. Organisms not native to a biome may move to or be transported to a foreign biome, but they tend not to thrive as well as the native organisms and tend to be eliminated. When the foreign organisms do thrive, they are considered invasive species because the biome's dynamic equilibrium changes and one or more native species tend to be eliminated. CESs can be used to more effectively and proactively study such impacts on biomes.

Very little is known regarding the long-term (multi-generational) effects of gravity levels either above or below 1 g on all known life and their biomes, as depicted for terrestrial biomes in FIG. 4, in which the Earth's biomes are shown as a thin skin at the 1 g level on the vertical axis. “An Artificial-Gravity Space-Settlement Ground-Analogue Design Concept” (Dorais, 2016) describes a concept that would enable a network of human-occupied PCESs subject to gravity levels above 1 g to be operated on Earth. However, fractional gravity under 1 g can only be generated for a few seconds on Earth, essentially by powered descent. Described therein is also a spacecraft design concept to orbit CESs that are subject to various gravity levels, both above and below 1 g for long-term study.

For about the first 3 billion years, the life on Earth appears to have been microbial with multicellular life not appearing until about 600 million years ago. To this day, microbes are essential for multicellular plants and animals. On average, humans have on the order of 10 times the number of microbes on and in their bodies than the number of their own cells. Most of these microbes are either benign or helpful, such as by aiding digestion, recycling organic materials, building up our immune systems, and protecting us from the small percentage of harmful microbe species.

Microbial biomes (microbiomes) are extremely complex and their impact on engineered environments is an active area of research (National Academies of Sciences, 2017). A single liter of water or earth may contain billions of microbes of a wide variety of species that are continually changing in quantity, evolving genetically, and interacting with each other as they compete for resources. Microbiomes exist within organisms, such as human intestines, aquatic environments, such as ponds and oceans, terrestrial environments, such as top soil, and engineered environments, such as buildings and CESs. Each microbiome requires some combination of fresh water and salt water as a base. Microbiomes can be extracted from their natural environments as well as be created in the lab by combining microbes and resources.

### Astrobiology

Astrobiology is defined by the National Academies of Sciences, Engineering, and Medicine (NASEM) as, “the study of the origin, evolution, distribution, and future of life in the universe.” (NASEM, 2018). Congress directed NASA and NASEM to develop an astrobiology science strategy, which is defined in (NASEM, 2018). This document describes a rapidly growing field and has several recommendations. The primary focus of the document appears to be on the search for extraterrestrial life as opposed to the study of life beyond Earth that originated on Earth. After 60 years of space travel, almost nothing is known about populations of organisms that are conceived and mature in space by competing for their survival and reproduction thereby evolving in space over multiple generations. The CCEDS develops CESs that are suitable for long-term spacecraft payloads to facilitate the study of the evolution, distribution, and future of life in the universe beyond Earth from life that descended from life on Earth.

### Controlled Ecological Life Support Systems (CELSSs)

In addition to improving the scientific understanding of organisms and their communities, CESs show promise as a means of life support for humans in space. NASA began a sustained effort to develop CELSSs in 1978 with the start of the CELSS Program to develop technologies to sustain sizable flight crews in space for extended periods by means of fully-integrated bioregenerative life support systems, which include biological and physico-chemical subsystems for recycling resources. These subsystems included:
“Biomass production (plant and secondary animal production)
Biomass processing (food production from biomass)
Water purification
Air revitalization
Solid waste processing
System monitoring and control” (Averner, 1990).

The CELSS Program funded a wide variety of activities including those focusing on CESs. Several of these activities were discussed at the CELSS workshop, “Workshop on Closed System Ecology” at which CES research was presented (NASA CR-169280, 1982). The unanimous findings of the workshop participants were:
“It may be much easier to achieve persistent materially closed ecosystems than had been believed in the past.
CES research promises to become a significant resource for the resolution of global ecology problems which have thus far been experimentally inaccessible because:
   Global parameters (e.g., O₂ or CO₂) of whole ecosystems can be monitored under controlled replicable conditions.
   Boundary conditions such as chemical, biological, and physical starting values and post closure energy fluxes can be varied experimentally.
   Global energetics of whole ecosystems can be measured and experimentally manipulated.
For the reasons just cited, closed ecology research may very well prove an invaluable resource for predicting the probable ecological consequences of anthropogenic materials on regional ecosystems.
CES research is an empirical resource for validating and calibrating general and special mathematical models of ecosystem structure dynamics and stability characteristics.
CES research may become pivotal in discovering the basics laws to which Controlled Ecology Life Support Systems (CELSS) must conform and in establishing the foundation for a CELSS control theory.” (NASA CR-169280, p. 2).

Subsequently, the growing concern regarding climate change and the increasing rate of species going extinct make the above findings even more prescient. These findings continue to be relevant for CES research and support the need for studies and systems addressing them.

Among the CES activities discussed at the workshop was a 1-liter CES containing microbes, algae, and Crustacea developed by J. Hanson that had persisted for nearly 2 years by that time (NASA CR-169280, p. 9). The following year NASA licensed the technology for this CES to a company that commercialized the product and began marketing ecosystems in 1983. To date, nearly 1 million of these CESs have been produced since then (EcoSphere History, 2018).

With the exception of nine Apollo missions, in the last 60 years of spaceflight all human-occupied spacecraft have not gone beyond low Earth orbit and only a few astronauts have continuously stayed in space more than 7 months. For these reasons among others, there has been little investment and little progress in CES research since NASA's promising start 35 years ago. Currently, it is simply less expensive to regularly ship supplies to flight crews than recycle resources. For the same reason, flight crews discard their clothing rather than washing them. However, this approach is short-sighted given NASA's goal is to extend human presence throughout the solar system.

Once CESs are demonstrated to reliably persist in space, within specified gravity and radiation limits, it is a small step for similar CESs to persist just about anywhere in space (Earth orbit, Moon, Mars, Earth-Mars cycler orbits, asteroids, . . . ) enabling life to permanently extend beyond Earth and grow exponentially. In 1986, Dr. Carl Sagan authored a magazine article titled, “The World that Came in the Mail” about a 5″ diameter EcoSphere closed ecosystem, in which he stated, “Such systems are being perfected and will play a key role in future human exploration of the solar system.” (Sagan, 1986), and in which he described a EcoSphere that he received (EcoSphere Carl Sagan Review, 2018). C. Sagan subsequently authored A Pale Blue Dot: A Vision for the Human Future in Space (1994) where he made a case for permanently extending life beyond Earth.

However, due to the complexity of CESs, they tend to be unpredictable and difficult to control, particularly those with animals, e.g., the largest animal species tend to go extinct first because the largest animals tend to have the large resource demands and low populations with respect to the other species in the CES they rely on, which would be the case for CESs and/or PCESs with humans.

### A Bioregenerative Life Support System Primary Challenge

Bioregenerative Life Support Systems present a number of challenges. However, the Earth's biosphere itself demonstrates the feasibility of such systems. It has functioned for about 4 billion years while subject to a wide range of destructive events, both geological and astrophysical. A primary reason for this resilience is suggested by FIG. 5.

Since the water within an organism can vary considerably, total carbon mass is commonly used as a biomass metric. A recent study of the Earth's total biomass distribution by type (Bar-On, Phillips, and Milo, 2018) is summarized in FIG. 5 by the table listing Gigatonnes of Carbon (Gt C) distributed by biomass type, which is graphically depicted by the layered triangle shown in the figure. The study does characterize the uncertainty of the estimates, which is highest for the microbes and lowest for humans. The majority of the plant biomass is due to tree species.

With respect to bioregenerative life support for humans, on Earth the order-of-magnitude ratio of human biomass to non-human biomass is currently 1:10,000, i.e., (0.06/(545.3-0.06)). However, due to the recent growth of the human population and deforestation, the general consensus is that the Earth's ecosystem would be more sustainable with fewer humans and more trees, pushing this ratio much higher, e.g., 1:100,000.

In contrast to the natural ratio of humans to other life, humans continue to migrate to cities at an accelerating rate, where the human biomass is orders of magnitude greater than the non-human biomass. Consequently, cities require a constant inflow of food, water, air, and other resources, and produce a constant outflow of wastes to a point damaging Earth's biosphere.

For humans in space, this extreme is pushed even further. On the International Space Station, a regular stream of supply spacecraft is required to sustain the lives of the crew. Most of these supply spacecraft are subsequently filled with wastes to be incinerated in the Earth's atmosphere. Other wastes, such as methane, are exhausted into space. This process is even less attractive for when humans live on the Moon, Mars, and beyond where bringing wastes back to Earth for disposal is not an option. The technologies that will enable humans to live sustainably in space will almost certainly be applicable to the cities on Earth benefitting all life.

The preliminary findings of CES research indicate that animal to plant biomass ratios much closer to 1:10 are achievable, at least for a few years as demonstrated by the success of EcoSpheres. It is desirable to explore the feasibility of different ratios for different combinations of species populations, eventually including humans.

### Overview

Described herein in accordance with certain embodiments is a Controlled Closed-Ecosystem Development System (CCEDS) that uses Evolutionary Computation (EC) for developing Closed EcoSystems (CESs) that may be externally controlled.

The CESs may have specie populations that enable each CES to persist indefinitely without the need to add resources, remove wastes, or require human intervention. Each CES is instrumented and controlled so that it can be remotely maintained, experiments performed, and data collected. Data from the entire population of CESs are managed in a cloud server database for analyses on how to improve the performance of each CES as well as formulate new CESs. These CES modules can be interconnected as well as operated on spacecraft to study life for indefinite durations under different gravity and radiation conditions with respect to their control group counterparts on Earth.

Present embodiments aim to facilitate permanently extending life beyond Earth as well as to better understand Earth's ecological systems and to achieve sustainability by 100% recycling of all resources in a closed environment in which no mass is permitted to enter or exit.

This basic architecture is applicable to a wide variety of CES model sizes, shapes, and materials. It is also applicable for supporting a wide variety of species, but it is primarily intended for populations of single-cell organisms, such as bacteria and phytoplankton, small plants, and small animals including mammals.

Manmade closed ecological systems are very complex in order to persist, are inherently unstable, and require human intervention to study and maintain. This invention automates this process and can be used to automatically create an enormous database of closed ecological systems used by data mining algorithms to discover patterns and perform control optimizations.

Closed Ecological Systems may be used to generate data for scientific research. They may also be used for aquariums or terrariums.

Although the arrangements described herein focus on an EC machine learning approach for developing controlled CES complex adaptive systems, the approach can be generalized to use a wide range of machine learning algorithms for the adjustably-autonomous development of complex adaptive systems.

A computational approach described herein focuses on CESs, but many of the techniques and models developed are applicable to partially-closed ecosystems (PCESs), particularly those in which the mass added and the mass removed are tightly controlled.

To generate data for the CCEDS and to test CES models generated by the CCEDS, a group of small CESs may be used to generate data without direct human interaction and that are continually optimized by the CCEDS by modeling the CESs based on the data they produce. Small CESs can be combined and/or expanded to very large sizes. One hypothesis is that these CESs can be made large enough and persist long enough to support human populations enabling people to live sustainably almost anywhere on Earth with much lower impact on each other and other life.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 shows a schematic diagram of a human-occupied controlled CES that would not require external sources of air, water, and food nor release any waste;

FIG. 2 shows an example of a CES that is partially terrestrial and partially aquatic;

FIG. 3 is a simplified Whittaker diagram characterizing biomes with respect to the mean temperature and mean precipitation;

FIG. 4 is a portion of the Whittaker diagram of the Earth's terrestrial biomes shown as a thin skin at the 1 g level;

FIG. 5 is a diagram summarizing a study of the Earth's total biomass distribution by type;

FIG. 6 is as schematic diagram of a CESM in accordance with certain embodiments;

FIG. 7 is schematic diagram of a colony of CESMs forming a CES governed by a CCEDS in accordance with certain embodiments;

FIG. 8 is a block diagram depicting the architecture of a CCDES in accordance with certain embodiments;

FIG. 9 shows an orbiting modular artificial-gravity spacecraft (OMAGS) equipped to carry one or CESMs;

FIG. 10 shows the orbiting modular artificial-gravity spacecraft of FIG. 9 in cutaway view in accordance with certain embodiments;

FIGS. 11 and 12 show an OMAGS payload centrifuge wheel CESM layout in top and side views in accordance with certain embodiments;

FIG. 13 shows an OMAGS centrifuge wheel CES rim module layout top cutaway-view in accordance with certain embodiments;

FIG. 14 shows an OMAGS centrifuge wheel CES rim module layout side cutaway-view in accordance with certain embodiments; and

FIG. 15 shows a smaller, low-cost version of an OMAGS spacecraft in accordance with certain embodiments.

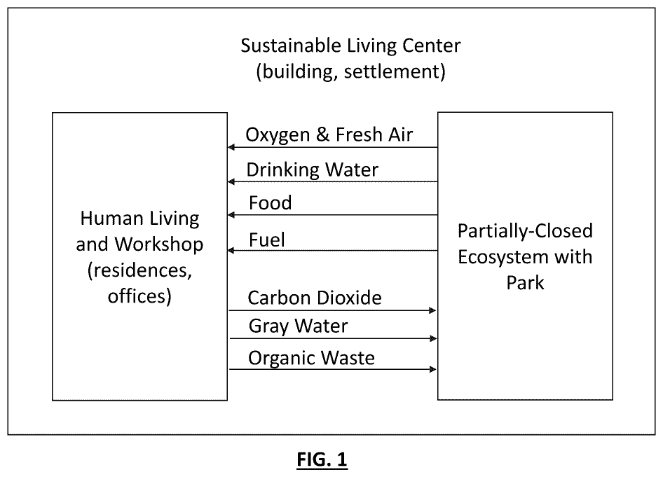

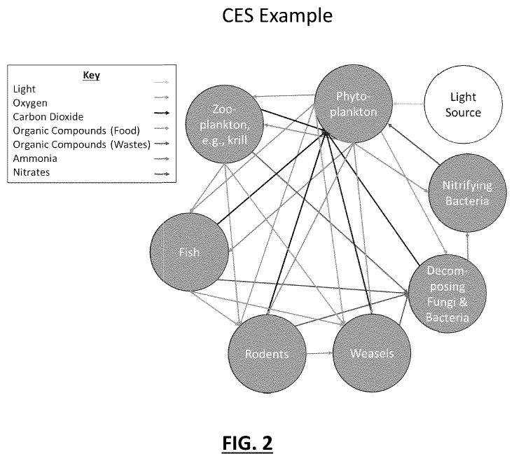

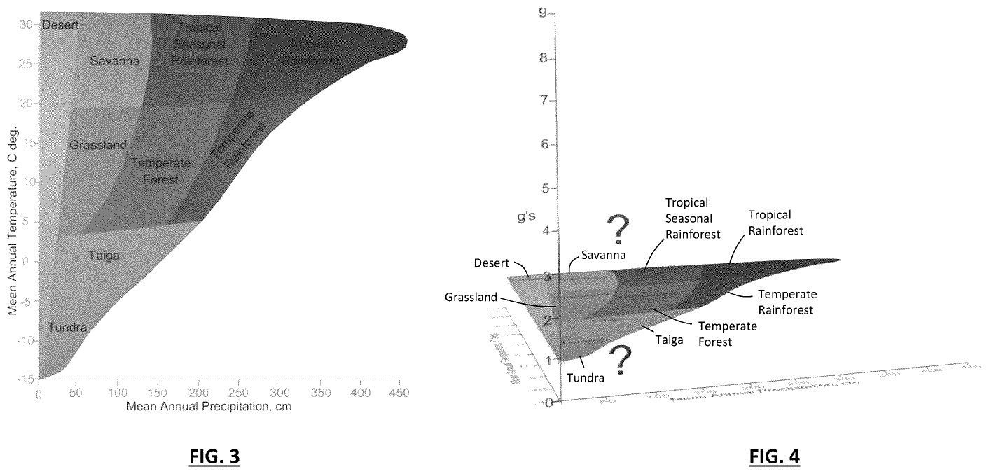

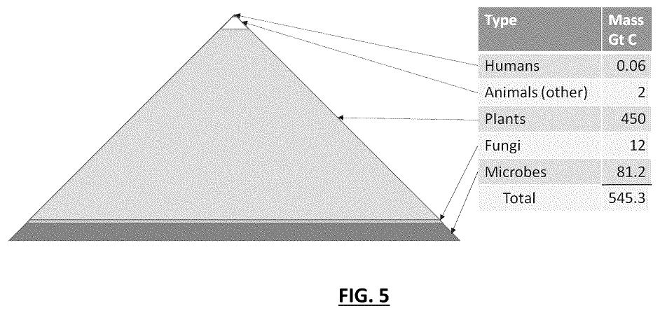

### DESCRIPTION OF EXAMPLE EMBODIMENTS

Example embodiments are described herein in the context of processors and controllers for implementing controlled closed-ecosystem development system. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

### Controlled Closed-Ecosystem Development System (CCEDS)

In accordance with certain embodiments, a controlled closed-ecosystem development system (CCEDS) includes closed ecological systems (CESs), each having one or more controlled ecosystem modules (CESMs) that each have a biome containing at least one organism, and equipment comprising one or more of sensors, actuators, or components that are associated with the biome. In certain embodiments, the CCEDS is governed by a controller that may use evolutionary computation (EC) to operate the equipment to effect transfer of material among CESMs, and to control other parameters, in order to increase or otherwise optimize one or more of organism variety, size, population, capacity, or sustainability of a biome of at least one CESM. As mentioned above, preliminary findings of CES research indicate that animal-to-plant biomass ratios much closer to 1:10 are achievable, at least for a few years as demonstrated by the success of EcoSpheres. In certain embodiments, the CCEDS can be used to explore the feasibility of different ratios for different combinations of species populations, eventually including humans.

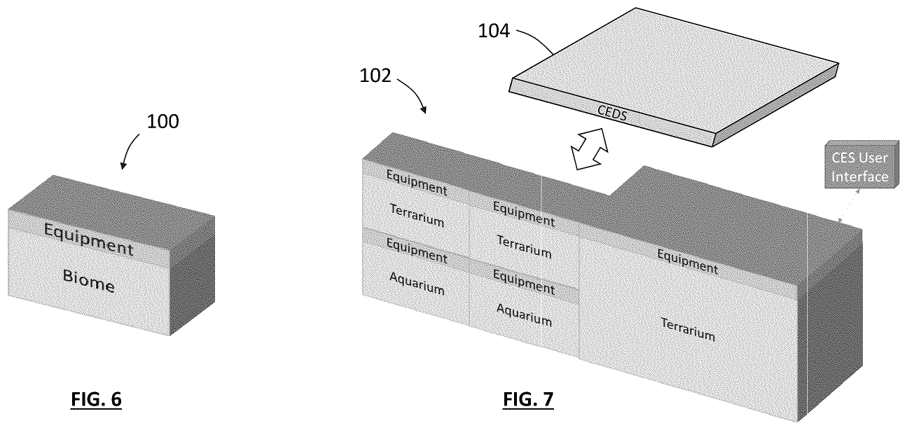

An example CESM 100 in accordance with certain embodiments is shown schematically in FIG. 6, while Tables 1-3 below provide non-exhaustive lists of sensors, actuators and components that can be used therewith. In FIG. 7, the CESMs 100 are shown combined into independent CESs 102 that are governed by a CCEDS 104 that uses the CESs to generate data to continually optimize the overall system.

Each CES 102 is a colony of CESMs 100. Once a microbiome is created, it is sealed and treated as a CESM. In certain embodiments, the CCEDS methodology for creating microbial CESMs includes extracting microbiota from a natural site, creating CESMs per recipes, for example, written by experts, evolving recipes by the CCEDS 104 from a population of recipes and creating CESMs per such evolved recipes, merging two or more CESMs, or a combination of these methods. The CESM is controlled such that the microbiome reaches equilibrium for a range of temperatures and lighting time-series. If microbes cannot survive under the CESM environment conditions, it is less likely that multicellular plants and animals can.

### Controlled CES Modules (CESMs) Equipped for Data Collection and Optimization

TABLE 1
CES Candidate Sensors

Sensor
Temperature Sensors
Microscopes
Imagers, variable frame rates
Multi-spectral Light Sensors
Pressure Sensors
6-axis Accelerometers
GPS/location Sensors
pH Sensors
Humidity Sensors
Spectrometers
Genomic Sensors
Magnetometers
Radiation Detectors

TABLE 2
CES Candidate Actuators

Actuator
Multispectral Lighting
Heaters/ Coolers
Humidifiers/Evaporators
Dehumidifiers/Brine Collectors
Precipitation Mechanisms, e.g., Misters
Water pumps & valves
Air pumps & valves
Organism gates
Fans
Robotic arms
Sampling Mechanisms
Electromagnets
Lasers
Vibrators
Augers

TABLE 3
CES Other Candidate Components

Component
CPUs
Memory Storage
USB Ports
Actuator Controllers
Analog/Digital Converters
Internet Controllers
Power Supplies

The colony of CESMs 100 that comprise each CES 102 can be coupled together in a wide variety of configurations that facilitate exchange of material, for example using mechanical means (not shown), to increase or otherwise optimize the organism variety, size, population, capacity, and sustainability of the CES. The transfer of gas, water, and organisms between CESMs 100 can be controlled (e.g., some CESMs may be designed to produce excess oxygen and others to produce excess carbon dioxide for example).

### CES Module (CESM) Types

Each individual CESM 100 can be configured in a wide variety of ways and can be reconfigured during operation, both mechanically as well as naturally to facilitate inter-CESM resource flows. For design and analysis purposes, it is helpful to classify CESMs by different quad-types, one type from each of the six classes: Environment, Biota, Climate-Temperature, Climate-Precipitation, Gravity, and Production. The CCEDS is free to blur these distinctions and morph the CESMs as needed.

In FIG. 7, CES 102 is comprised of 2 aquarium CESMs 100 and 3 terrarium CESMs 100. If for some reason, most of the water from one aquarium was pumped into the other CESMs, the same CES would then be comprised of 1 aquarium and 4 terrariums. Each of these CESMs may have a different climate, support a different set of species, and perform a different function in the CES by contributing different resources that benefit the other CESMs. Of course, other CES compositions are contemplated.

Since microbes play a critical role for all life, they play a foundational role in the development of the CESs for the CCEDS. Due to the complexity of the microbes in the environment as well as in each plant and animal, the CCEDS does not model the individual microbes or even the microbe species. However, the CCEDS does model classes of microbe species, such as phytoplankton, which convert light to chemical energy, and select individual species that can be used as measures of the health of a microbial CES.

In certain embodiments, once a microbial CESM reaches equilibrium and is deemed suitable for use in a CES with multicellular plants and animals, the microbiome CESM is selected for propagation. For an aquatic CESM, for instance, this is accomplished by creating one or more sterile CESMs with filtered water, filtered air, and filtered carbon dioxide, from commercial tanks or dry ice, which sublimates. These ingredients provide the necessary elements for life: hydrogen, oxygen, carbon, and nitrogen, as well as other trace elements in the air and water. Other materials can also be added, including non-reactive materials such as synthetic gravel, to provide a healthier environment for the various microbes to live. One or more of the sterile CESMs can then be connected to the microbial CESM selected for propagation. Pumps may be used to mix the waters so that each connected CESM has approximately the same amount of water with the same microbe populations. Once this connected network of CESMs reaches equilibrium, they can be marked as part of the same lot and then separated. The process can be repeated as needed.

In certain embodiments, each CES microbiome lot is treated as the same species. They reproduce as described above, but they can also create new microbiome lots by combining microbiome CESMs from two or more different lots. The ancestry of each of these microbiome CESMs is tracked like one would track the breeding of animals, such as horses or dogs, with the exception that a microbiome can have any number of parents.

Microbial terrestrial CESM preparation is similar to the preparation procedure for fresh-water aquatic CESMs with the following exceptions:
The terrestrial initial microbial population sample is based on soil instead of water, but water is added.
Sterile terrestrial CESMs include sands and powered carbon in addition to the ingredients for sterile aquatic CESMs. Note that the total carbon mass in a CESM limits the maximum biomass in the CESM (unless it is connected to anotherCESM).
In order to connect a sterile terrestrial CESM with a microbial terrestrial CESM such that the microbe populations are uniformly distributed, the soils in the CESMs must be mixed. A uniform distribution is not required, but then the performance of each CESM may vary considerably. Mixing can be accomplished by placing the soils from all the CESMs into a tumbler where they are mixed like a cement-mixer mixes cement. The liquefied soil can then be pumped back into the CESMs like cement can be pumped for construction purposes. Another alternative for mixing soils is the use of underground augers running the length of the CESMs to ports connecting the CESMs. By rotating the augers, soil is mixed and moved from one CESM to the next. Augur-equipped CESMs do not mix the soils as effectively as the tumbler approach, but they can be used over the operational life of the CESMs. Plants and animals can also be used to redistribute soil between CESMs as needed.

As with the microbial aquatic CESMs, once the connected microbial terrestrial CESMs reach equilibrium, they are marked as part of the same lot and then separated.

Once a microbial CESM reaches equilibrium, multicellular plants and/or animals can be introduced to it via a CESM port. Doing so will generally disturb the CESM equilibrium depending on the size of the CESM and the specimens added. Once the specimens are added, it may be necessary to connect the CESM with one or more other CESMs in order to reach a new equilibrium. For example, one CESM with animals may produce excess carbon dioxide and require additional oxygen, while another CESM with plants may produce excess oxygen and benefit from additional carbon dioxide. Microbial CESMs without multicellular plants and animals can also reach new equilibria where they effectively convert carbon dioxide to oxygen, or convert oxygen to carbon dioxide, for other CESMs.

### Aging and Evolution

Aging is a familiar characteristic of multicellular plants and animals. A 1-year old tree, a 10-year old tree, and a 100-year old tree are clearly distinguishable. The same holds for humans. In addition, plants and animals have well-defined life spans. They essentially are designed to die such that it would be an incredible surprise if such an organism did not age. The same does not hold true for a microbiome in a CESM, which can be considered as a single multicellular, multi-genome organism. Once the microbiome reaches equilibrium and its environmental temperature, radiation, and gravity levels do not stray from their established norms, the organism does not appear to age. We hypothesize that a 1-year-old CES microbiome, a 10-year-old CES microbiome, and a 100-year-old microbiome may be completely indistinguishable by experts. Rather, it appears as if they could live indefinitely. As is the case for multicellular plants and animals, microbial cells reproduce and die. However, a resource-producing organism that the microbiome comprises may be able to continually produce oxygen, or carbon dioxide, or food, among other things, indefinitely. The above hypothesis depends on gravity being held at 1 g.

Establishing microbiome equilibrium at a different gravity level may be possible and may result in microbe populations evolving in the process, but could take considerable time to confirm, given the 4 billion years of microbial evolution at 1 g. The evolutionary paths that microbiomes follow at fractional gravity levels may be predicable given sufficient time and quantity of CES samples subject to fractional gravity. This could have consequences for all life subject to fractional gravity for extended periods.

The growing concern regarding climate change and the increasing rate of species going extinct make the above findings even more prescient. These findings continue to be relevant for CES research and support the need for systems such as the CCEDS.

The following CESM types are useful building blocks and are offered as examples, but the system may evolve a much wider portfolio to draw from over time:

### Environment (General) Types

Aquarium—The CESM water surface area is significantly greater than the land surface area. There may be no land surface area. Water provides additional protection from radiation and rapid thermal changes for space CESs. The salt content can vary from fresh water to sea water.

Terrarium—The CESM land surface area is significantly greater than the water surface area. There may be no water surface area. This CESM generally requires more volume for an atmosphere than an aquarium CESM to support larger land animals and plants.

Coastal (Aquarium/Terrarium bridge)—The CESM land surface area and water surface area are similar in size. This CESM type can act as a bridge between an aquarium CESM on one side and a terrarium CESM on another side.

Subterranean—This is a variation of a terrarium CESM in which there is no water surface area and most of the volume consists of soil for harboring underground biota. The soil provides additional protection from radiation and rapid thermal changes for space CESs.

### Biota (Prominent) Types

Microbiome—Microbes play a critical role in all CESs. Microbes will persist in all viable CESMs, but having a persistent source of microbes as well as the resources they can provide, e.g., oxygen, makes it an important CESM type.

Botanical Garden—Plants account for the vast majority of all the biomass on Earth playing key roles for the nutrition and oxygen for animals, both terrestrial and aquatic. This CESM type also includes support animals, such as worms, snails, and other Spiralia.

Insectarium—Insects may not be essential for some CESM colonies, but they do play important roles in Earth's ecosystem, such as pollination and as a nutrition source. Candidate species include bees and ants. Although technically not insects, this CESM type may benefit by including arachnids.

Amphibian Zoo—Amphibians are an optional set of species, but may play an important role in controlling insect populations and as a nutrition source for other species.

Reptilian Zoo—Reptiles are also optional for many CESM colonies, but may play an important role in controlling a wide range of species populations, including mammals.

Aviary—Aviaries are optional for CESM colonies. Birds can be both aquatic and terrestrial foragers, as well as effective at spreading and fertilizing seeds. A bird can also literally act as “the canary in a coal mine,” sensing the suitability of the atmosphere for sustaining life. Little is known about bird flight under different gravity conditions.

Aquatic Biota—Rather than segmenting the aquatic biota into subcategories, they are grouped together in this type to support a wide variety of plant and animal combinations. Separate CESMs may be useful to support incubation and maintain diversity.

Mammalian Zoo—This CESM type focuses on supporting mammal populations of increasing size to eventually demonstrate that human populations can sustainably thrive in CESMs since this is the ultimate goal of this effort. However, initially the plan is to start with rodents, weasels, and other small mammal populations that look promising for persistent CESs.

### Climate-Temperature Types

Arctic—CESMs with annual temperature ranges that fluctuate above and below 0° C. such that surface ice forms and melts, but does not get so thick so that it jeopardizes the CESM's biota. Many organisms important to Earth's ecosystem, such as phytoplankton and krill, thrive in colder temperatures.

Temperate—CESMs with moderate daily and seasonal temperature ranges that fluctuate above and below 20° C. This temperature range supports a wide variety of Earth's biota.

Tropical—CESMs with daily temperature ranges that fluctuate above and below 30° C. This temperature range is conducive for biota not suitable for cooler temperatures.

### Climate-Precipitation Types

Dry—CESMs with an annual precipitation between 0-50 cm. Additional water can be provided by a subsurface source and an oasis can support life in lieu of precipitation. CESMs with high concentration of animals may thrive better in a dry climate as long as a water source is available. This type of CESM may also be suitable for evaporating brines and salt storage.

Moderate—CESMs with an annual precipitation between 50-175 cm. The distribution of this precipitation can vary seasonally to encourage plant growth.

Heavy—CESMs with an annual precipitation between 175-400 cm, primarily for supporting tropical biota.

### Gravity Types

CESMs can be subject to a spectrum of gravity levels that remain constant or that may continuously change. On Earth, the CESMs are limited to Earth and Hyper gravity levels. In space, Micro, Lunar, and Martian gravity levels are of particular interest due to their proximity to Earth and potential to harbor life.

Micro—CESMs subject to acceleration near 0 m/s²; a gravity level suitable for simulating spacecraft cruise flight conditions, such as present on the International Space Station.

Lunar—CESMs subject to acceleration near 1.6 m/s²; a gravity level suitable for simulating Lunar near-surface conditions.

Martian—CESMs subject to acceleration near 3.7 m/s²; a gravity level suitable for simulating near-surface conditions on Mars.

Earth—CESMs subject to acceleration near 9.8 m/s²; a gravity level suitable for simulating near-surface conditions on Earth. This is the baseline gravity type for CESMs.

Hyper—CESMs subject to acceleration above 9.8 m/s²; a gravity level suitable for simulating a gravity-level differential on Earth by means of centripetal acceleration. The effects of rotating CESMs can be tested on Earth before testing them in space. Also, similar CESMs can be subject to long-term tests at different gravity levels including enabling organisms to travel between CESMs subject to different gravity levels. Different organisms within a species and different species may thrive in hypergravity environments for a variety of reasons. Hypergravity simulator benefits and design consideration are discussed in (Dorais, 2016).

### Production Types

Oxygen producer—CESMs that produce excess oxygen in exchange for carbon dioxide.

Carbon dioxide producer—CESMs that produce excess carbon dioxide in exchange for oxygen.

Vegetation producer—CESMs that provide plant nutrition for animals.

Meat producer—CESMs that provide meat nutrition for animals. In the long term for the Darwinian evolutionary selection process to function, animal populations must be culled based on their fitness with respect to their environment. This is particularly important for a species population to adapt to a foreign environment, such as those in space.

Fertilizer producer—CESMs that provide nutrition for plants. The primary source is microbes and the waste they feed on.

Pollinator producer—CESMs that enable plants to pollinate and disburse seeds. Naturally, this is done by wind and some animals. However, a CES could be equipped to perform this task mechanically.

Mineral producer—CESMs that provide mineral nutrition for biota. By definition, all CESs are closed so the total mineral content is fixed. However, over time the minerals may become distributed in a way that hinders growth in some CESMs such that mineral redistribution is required. This can be accomplished by strategically controlling water flow as well as by animals and mechanical means.

Universal producer—CESMs may serve different functions for the depending on what is needed at any particular time. A universal-producer may be tuned by the CCEDS to produce oxygen when needed; and then be re-tuned to produce carbon dioxide to prevent the oxygen level in other CESMs from becoming too high. Because of their flexibility, universal producers can be independent from other CESMs. One strategy a CCEDS may employ is to keep universal producers disconnected from the other CESMs unless they are needed in order to protect the flexible capability and diversity of their role as universal producers. Otherwise, CESMs may specialize over time and lose their flexibility as universal producers.

These CESM building blocks can be combined in a variety of ways during the CES design process as well as dynamically reconnected and individually retuned during operation as directed by the CCEDS operating in conjunction with human experts. This operation can be extremely complex to perform effectively. The CCEDS relies on evolutionary computation to manage and optimize its continually adapting CESs.

### CCEDS Architecture

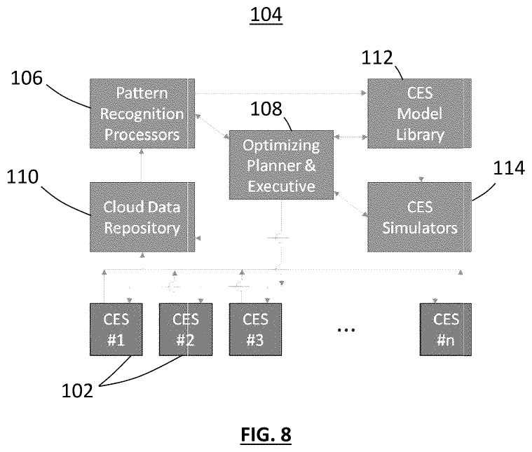

FIG. 8 depicts the architecture of CCDES 104 of FIG. 7. In certain embodiments, the architecture consists of the following five CCEDS control system elements in addition to its population of CESs that generate data for and execute commands from the CCEDS control system. Other CCEDS control system elements are also contemplated. The five listed herein are not exhaustive. Together with optional inputs from human experts, the CCEDS control system elements form an adjustably-autonomous, self-optimizing network for closed ecosystems in which data collected from each physical CES and the CES simulators are used to optimize the individual CESs and the CES Model Library Artifacts. The five CCEDS control system elements are briefly described below. The architecture simultaneously supports one or more independent CESs, each comprised of a colony of one or more CESMs that can be dynamically interconnected within the CES by command.

### Pattern Recognition Processors (PRPs)

The PRPs 106 detect patterns in the data from the CESMs 100 as well as the CCEDS control system elements. One or more PRPs may be provided. Because of the large amount of time-series data a population of CESs 102 can continually generate, including images, and the complexity of the patterns hidden in this data, which continually change over time, the computational resources required to maximize the potential of the PRPs 106 in discovering useful patterns are not bound. This element of the architecture can function with a single processor, but the design is computationally distributed so that it can take advantage of any level of computational resources that can be made available. In addition to CPUs and GPUs, cloud computing and specialized processors, such as Tensor Processing Units, analog processors, and neuromorphic processors, can be candidate processors.

### Optimizing Planner and Executive (OPE)

The OPE 108 uses patterns discovered by the PRPs 106 to optimize the CESs 102 and the CCEDS control system elements. The OPE 108, acting as a system controller, can either operate in a command mode or advisory mode for each CES 102. In command mode, the OPE 108 issues commands to each CESM 100 based on its overall analysis of the CESs 102 in order to optimize the value of the data generated by the CESs, maximizes the persistence of CES organisms, and/or other system-level objectives. In advisory mode, the OPE 108 issues status reports, advisories, and CESM controller command sequence change recommendations to the CES user interface. In certain embodiments, human experts/users determine which command changes are warranted and executed by its CESMs. In both modes the CCEDS issues software updates to the CESM controllers and CES user interface.

### Cloud Data Repository (CDR)

The CDR 110 stores sensor data and command logs received from the CESMs and the CES simulators. The CDR also services data access requests by the PRPs 106 and CES simulators.

### CES Model Library

The CES model library 112 element is a repository for artifacts used by and/or optimized by the OPE 108 and PRPs 106, as well as by human experts. Some of these artifact types are listed in Table 5.

TABLE 5
CES Model Library Artifacts

Library Artifact
Organism Models
Environment Models
CES and CESM Recipes
Resource Recipes
Inter-CESM Configurations
Intra-CESM Configurations
Control Algorithms
Heuristics
Simulation Scenarios
Simulation Histories
CES and CESM Predictions

### CES Simulators

In certain embodiments, CES Simulators 114 are provided that can run much faster and simulate many more variations of simulated CES systems by a few orders of magnitude than the physical CESs 102, which are used to validate the simulations. A CES simulator 114 can run at a variety of fidelity levels selected as needed. High fidelity simulations require more computational resources and take longer to simulate a period of time, which can be very long, such as for the case when the simulation exit criterion is that the CES becomes sterile. Low fidelity simulations run faster, but with the disadvantage of the results tending to be less reliable. In many cases, it is more valuable to quickly have many rough estimates than to have a few very accurate estimates. In other cases, such as when diagnosing an unexpected result, accurate estimates are more valuable and worth the wait.

### Evolutionary Computation

Evolutionary computation (EC) is the area of computer science that encompasses stochastic design and optimization algorithms based on rules derived from evolutionary theory and genetics. EC is often suitable for solving problems not amenable to traditional approaches as well as to better understand not only nature, but complex adaptive systems in general. CESs are such systems and in certain embodiments the CCEDS 104 uses the EC approach in its operation.

The essence of EC algorithms, such as the one used by the CCEDS 104 herein, is described by the following 5-step process:
1. A limited population of candidate models is generated
2. The population is reproduced with deviations
3. The fitness of each member of the population is determined
4. The least desirable members are either removed or made less likely to reproduce
5. Return to step 2 until the exit criteria are met

The EC algorithms employed by the CCEDS 104 in certain embodiments can be based on EC algorithms described in for example Dorais, 1997, which is incorporated herein by reference in its entirety. The EC algorithms are evolved recursively in order to optimize the wide range of parameters EC algorithms can use for a particular domain, in this case CESs 102. The model representations of the physical ecosystems are also evolved by EC algorithms to determine the best model representation. A model that is too simple or too complex will not effectively predict the life cycle of a CES under various conditions.

### CCEDS Evolutionary Computation Step Details

The 5-step EC algorithm specified above summarizes the process, but the details are tailored for the application. The following describes each step in more detail as it applies to the CCEDS application in accordance with certain embodiments.

### Step 1: A Limited Population of Candidate Models is Generated.

This step entails three significant design considerations: the model population limits, the model representation schema of the population elements, and the initial model generation process.

The model population limits are dependent on the size of the model search space and its complexity. If the limits are too small, then the algorithm will prematurely converge on a local optimum, overlooking better solutions. If the population is too large, it can slow the optimization process. If the population size exceeds the search space, the algorithm simply becomes an exhaustive search where the optimal solutions are in the initial population. For this application, the possible solutions are effectively infinite so exhaustive search is not an option. The enormous size of the search space is due to the number of parameters used to define each model, the number of values each parameter can take, and several other factors. The CCEDS process grows the number of model parameters and their ranges so the search space increases over time. This is not problematic because life does not have to exist in optimal conditions and environments to survive, but it helps increase the odds that CESs will persist if their models continually improve.

The limited model population is divided into a number of subpopulations, each with their own limits. This is done to help the algorithm to more thoroughly explore the search place rather than focus on the simplest, most promising solutions.

The model representation schema for CES can be extremely complex, so finding the model complexity balance is continually being tuned as part of the algorithm optimization process.

Nature encodes the model of each organism in DNA. Given the DNA, nature can reproduce the organism. However, how nature does this for a single organism is still beyond the capability for computers to simulate. A CES 102 is comprised of one or more CESMs 100, with CESMs being added to and removed from the CES over its operational life. Each CESM can be controlled over time differently, be a different size, be connected to other CESMs differently, and contain billions of microbes that widely vary genotypically and phenotypically, the vast majority of which can be unknown to science. The CESM schemas used may be extreme simplifications, but are designed to be sufficiently complex to improve the likelihood of CESs persisting.

The initial population of models can be randomly generated, where each model parameter is randomly selected from its range of values. This would distribute the possible solutions across the search space, but would not be productive. Most of the solutions would not be helpful in that they would either define a CES that clearly would not be viable as determined by an expert or would not be meaningfully different, which would waste computation resources. Initially, the population is seeded with models, for example from experts, for CESs that are known to be viable and/or help direct the search as well as models extrapolated between expert-specified models. This is part of the adjustably autonomous aspect of the CCEDS algorithm. It can benefit from the advice of experts while still exploring options that experts have not considered.

Step 2: The Population is Reproduced with Deviations.

This step uses variations of genetic algorithms. Nature either uses asexual or sexual production to produce organisms with DNA that are similar, but different from the parent organisms. In asexual reproduction, a cell divides with attempt to duplicate the DNA, but errors can occur, which are called mutations. The mutation rate is highly dependent on the radiation the organism has been subject to prior to and during the reproduction process. The CCEDS genetic algorithms use a tunable mutation rate to enhance the search space depending on the complexity of the local regions of the space being explored.

Sexual reproduction is a far more effective mechanism for exploring complex, dynamic search spaces. In a CES 102, as on the Earth, the search space is continually changing. Organism populations that once thrived may no longer do so because the environment including other species have changed. Sexual reproduction introduces the concept of DNA chromosome crossover where the DNA of the species is divided into multiple chromosomes and is combined in a way that the offspring receive DNA from both parents, both of which have had to survive long enough in the current and prior environments in order to reproduce, thus demonstrating their fitness, filtering out DNA that is currently less effective. It is incredibly amazing that this crossover process actually works. It is similar to taking multipage blueprints for two different computers, randomly tearing each page into multiple pieces, mixing the pieces for each page for both computers together, randomly selecting the pieces for each page, attaching them together, manufacturing a new computer according to this new blueprint, and the new computer almost always works! The CCEDS algorithm uses crossover to combine the design of two or more models in the population in addition to mutation to generate the next generation with deviations. Unlike nature, but similar to genetic engineering, this algorithm does not restrict organisms from having more than two parents.

### Step 3: The Fitness of Each Member of the Population is Determined.

This is the most challenging step and is continually tuned as part of the algorithm optimization process. It involves essentially analyzing the model parameters of each model in the model population and deciding how a CES 102 built and controlled according to these parameters will persist over time compared to the other models. Even an expert looking at multiple physical CESs may have trouble determining which CESs are more likely to persist longer, and it may not even be clear what is being optimized, i.e., how is fitness defined? In nature, fitness is associated with both organisms and species. Stochastically, the more fit organisms reproduce and the more fit species persist. Fitness is not necessarily a function of size, strength, intelligence, beauty, or dexterity. However, it is a function of adaptability, which depends on a wide variety of attributes. The fitness function of the CESs 102 focuses on the species and classes of species instead of the individuals, but this simplification is only the first step in the fitness function optimization process.

It may first appear that the problem of defining a CES fitness function is simple. If the CES contains living organisms, the function value is 1, otherwise it is 0. However, such a fitness function is not very helpful in guiding the search process. Its one redeeming value is that once everything is dead in a CES, nothing will spontaneously generate so the CES can be repurposed. Also note that the fitness function of a model is different than the fitness function of a physical CES 102 where sensors measure the CES state. In addition, a binary fitness function does not capture the uncertainty of the assessment. The probability of false positives and false negatives are not captured. Also, this binary fitness function is not predictive and does not guide the search process by enabling the ranking of the physical CESs as well as the CES models in the CCEDS algorithms population.

So instead of a binary fitness function, consider a numeric measure such as biomass kg, e.g., the higher the biomass, the more fit the CES. This has several problems as well. With EC systems one needs to be careful of what is ranked highly. For instance, it may turn out that the highest biomass is achieved by killing all the plants and animals so that their carbon can be used for microbes.

Given that the long-term goal of this effort is to sustain human life in CESs or PCESs, couldn't mammal count be an effective fitness measure such that the greater the quantity of mammals in a CES is, the more fit the CES is? This metric also has several problems. Consider a CES 102 that supports a population of mice and the CCEDS 104 is trying to maximize the count. One outcome is that so many mice are born that all the food and oxygen are consumed and they all die. Suppose that the CCEDS predicts this outcome and provides the needed food and oxygen; then the mice reproduce until it becomes so crowded that the female mice stop reproducing. Once the youngest female mouse reaches menopause, the CES is doomed. The mammal count remains high for a while, but one by one they die of old age until the species is extinct.

The mammal count is an important part of the fitness of a CES, but it is more complicated than simply the maximizing of the count. Recognizing the mammal population requirements, e.g., food, and the negative environmental effects it produces, e.g., wastes, are considered key to an effective CES fitness function that stochastically predicts mammalian sustainability. Also key to an effective fitness function is accurately predicting the CES's ability to maintain the cycle balances and the CES adaptability that the mammal population depends on.

The fitness function can be simply calculated as described above, or be learned by a deep neural network. Current fitness function design methodology can focus on using simulators that use deep neural networks as well as other algorithms to assess fitness according to a method that is continually optimized using both machine learning and expert knowledge.

### Step 4: The Least Desirable Members are Either Removed or Made Less Likely to Reproduce.

The step applies the Darwinian concept of the “survival of the fittest.” Simply applied, the population is sorted by fitness and only those models above a certain cut point are permitted to reproduce. However, this approach can lead to premature optimization on a local minimum. Another simple, but generally more effective method is to stochastically select which models reproduce, with the probability of being selected based on each model's fitness. This method is also too simplistic for CESs for the same reason.

Because ecological environments are dynamic and cyclic, this step must be applied with caution. For example, in nature, larger organisms tend to reproduce less frequently than smaller ones and there are several reasons why this strategy is effective. One of them involves the fact that large mammals take several years before reproducing. The Darwinian explanation for this is that it takes such organisms that long to mutually determine their fitness to reproduce and to select environmental conditions that will increase the probability that their progeny will also survive long enough to reproduce.

For CCEDS models, this process is accelerated by simulating the fitness of the models several years into the future under a variety of conditions. Still, these simulations may be crude approximations at best even though the CCEDS process continually improves them. There is significant uncertainty in the fitness assessment for each model in the population, for several reasons including because their environments can change, either by command or due to internal CES reactions. In the CCEDS algorithm, CES models are removed stochastically based on fitness, but instead of necessarily being deleted, there is a chance that they are either transferred to a different subpopulation being evolved (similar to a major-league athlete being traded to a minor league), or stored in the CES Model Library 112 with a chance to be resuscitated for use at a later time (cryonics analogy).

### Step 5: Return to Step 2 Until the Exit Criteria are Met.

Normally, for EC algorithms, this is the simplest step. For the CCEDS 104, one can make the case that it never stops. There is always a chance that a better model will be found. What the best model could be is not known; and even if it were found, the environments are continually changing so it would need to change too. The intent is for CCEDS algorithms to run indefinitely and in parallel on as many processors that are available. Options for crowd computing to support this effort are possible.

Instead of using this step to determine if it should stop, the CCEDS 104 uses this step to optimize the CCEDS algorithm itself including everything from fitness functions to simulations. One method the CCEDS uses to accomplish this is to apply different CCEDS algorithms (evolution strategies) to different model subpopulations. Step 1 describes that subpopulations are used to explore different regions of the model search space. In this step, subpopulations are created by duplicating existing model populations and evolving them with different evolution strategies in order to determine the fitness of the evolution strategies so that the evolution strategies are evolved by means similar to the model evolution algorithms. This process of evolving the evolution strategies can continually be applied recursively.

### CCEDS Evolutionary Computation Levels

Based on an extension of the multi-level EC algorithm presented in (Dorais, 1997), the CCEDS 104 performs variations of the above 5-step algorithm at the following 5 different levels of the CCEDS:

EC level 1: CESM Parametric Level

The CESM artifacts listed in Table 5 contain a large number of parameters, such as counts, sizes, limits, rates, etc., which affect the development and operation of CESMs 100. At this level, EC is used to explore permutations of these parameters.

EC level 2: Intra-CESM Symbolic Level

The CESM artifacts listed in Table 5 contain symbolic structures, such as procedures, which also affect the development and operation of CESMs. At this level, EC is used to explore permutations of these structures similar in principle to the way genes are permuted and exchanged when passed from parents to offspring.

EC level 3: Inter-CESM Exchange Level

The CESMs 100 can be selected and combined in a wide variety of configurations when assembling a CES 102 and operating it. At this level, EC is used to explore permutations of the connections between the CESMs and how they are tuned to benefit their CES, such as by controlling a CESM to produce more oxygen and transfer it to another CESM.

EC level 4: Inter-CES (CESM Colony) Communication Level

Although the CCEDS 104 controls a population of independent CESs 102, by detecting patterns in the data from the population of CESs it is currently managing as well as from stored data from other CESs in the CDR 110, the CCEDS uses EC, statistics, and other computational techniques to improve its performance in operating its current CES population as well as creating specifications for new CESs.

EC level 5: CCEDS EC Algorithm Level

The CCEDS algorithms themselves are subject to EC at this level. In certain embodiments, a population of CCEDSs 104, each with a different EC algorithm, some slightly different and others significantly different, each controlling its own population of CESs, can be deployed. These independent CCEDSs can mutually improve each other by interacting at this level. Based on how the CESs perform for each CCEDS, the fitness of its EC algorithm is determined enabling each CCEDS to use EC to improve its CCEDS algorithm over time. Also, instead of physically requiring a population of independent CCEDSs to accomplish this, at this level a single CCEDS 104 can create virtual variations of its EC algorithm (evolved clones), which it tests in its simulators to assess the fitness of each EC algorithm in order to use EC to evolve its EC algorithm. In addition, the CCEDS strategically uses its CESs to test these EC algorithm variations and to validate its CES simulators.

### Design Strategies

The design problem addressed by the CCEDS 104 can be viewed as an enormously complex, nondeterministic search problem in an n-dimensional space that continually changes unpredictably where n is effectively infinite. Each organism in each species in a CES 102 is continually adapting to the CES environment and aging. Even microbial ecosystems in engineered environments, such as buildings and vehicles, are not well understood and pose significant health threats to humans and other species.

In order to increase the probability of improving the viability of CESs 102, the CCEDS 104 is guided by the following design strategies.
1. Start small: Small in the size of the CES, organisms, number of CES, number of organisms, number of species of organisms, and CES volume. A small start enables rapid adaptation of the CCEDS and its processes, which facilitates rapid, low-cost progress.
2. Scale up the sizes of successful CESs by combining them with other CESs by interconnecting their CESMs.
3. Scale up the number of similar CESs and CESMs (use a batch development process to create a set of CESMs) to establish the repeatability of the control protocols used to manage the CESs during their lifecycles.
4. Vary the control protocols of some CESs to determine the effectiveness of various control protocols maintaining some CESs as the experiment control group.
5. Control the flow of resources and organisms between CESMs to maintain separate biomes and provide biological firewalls within a CES.
6. Simultaneously perform depthwise and breadthwise search for model development by using model subpopulations. Maintaining multiple model subpopulations avoids premature convergence on solutions, i.e., avoids local optima.
7. Use an adjustably autonomous approach that enables human experts to partially bias the search. By simultaneously performing breadthwise search, the EC algorithm can still discover solutions not imagined by the experts.
8. Continually optimize the optimization process using the EC algorithm.

### Orbiting Fractional-Gravity Closed Ecosystems

### Fractional-Gravity Closed Ecosystems

On Earth, CESs are strongly affected by the gravity generated by the mass of the Earth and are shielded from strong solar radiation and galactic cosmic rays by Earth's atmosphere and magnetic field. In order to create CESs orders of magnitude smaller than the Earth that can function without the Earth, the desired gravity level and necessary radiation shielding must be provided by other means.

CESs can be used as spacecraft payloads to study the long-term effects of various gravity and radiation environments on life. A CES is a useful spacecraft payload because of the scarcity and high value of mass in space. Resupplying the payloads with products from Earth and disposing of waste byproducts are not required. Also, CESs do not require flight crew attention so they can function for long durations on manned and unmanned spacecraft. CESs that are capable of supporting mammals significantly reduce the costs of space habitats enabling very long-term research of mammals subject to various gravity and radiation levels. CESs hold the prospect of permanently establishing life beyond Earth; initially with microbes, plants, and small animals, but ultimately in CESs with humans.

### Orbiting Modular Artificial-Gravity Spacecraft (OMAGS)

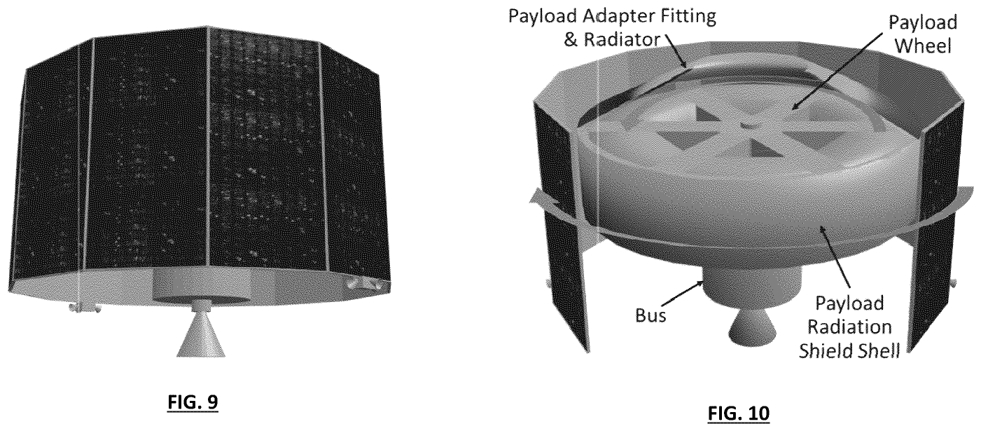

OMAGS is a fractional gravity spacecraft design for CES payloads and is depicted in FIGS. 9 and 10 (cutaway view). It is a cislunar spacecraft with a 150 cm-radius centrifuge. This centrifuge has a 2-ton bioscience payload capacity that produces artificial gravity by rotating 24 CESMs totaling 3,000 liters in volume. The bioscience research enabled can vary by each CESM and cover areas of fractional gravity, bioregenerative life support, and deep-space radiation-effect mitigation on the communities of biota in each CESM, including the microbiomes inside the multicellular organisms in the CESMs.

The spacecraft mission design is for a minimum of 5 years, but could extend much longer to observe the long-term effects of deep-space radiation and fractional gravity on biota communities from microbes to small mammals. The Voyager 1 and 2 spacecraft were both launched in 1977 and are still operational after 40 years. The longer an OMAGS-like spacecraft operates, the more valuable the data is from the CES payloads since the organism populations will have had more time to adapt and evolve to the space environment.

The primary factors limiting mission duration are propellant and radiation shielding. For a fixed launch mass, these two factors can be traded to optimize the mission.

Although not depicted in this design, an OMAGS-like spacecraft could be configured as a Lander for long-term operation on Phobos, Deimos, or an asteroid. Doing so would eliminate the need for propellant after landing, provide additional radiation shielding and minute gravity, but would require additional communication considerations, such as using a relay, and larger solar panels that could unfold to compensate for the loss of solar power due to the rotation of the moon or asteroid.

The Spacecraft and Payload Centrifuge Wheel counter-rotate resulting in net zero angular momentum and zero gyroscopic forces. The spacecraft mass without the Payload Centrifuge Wheel is ˜12 times more than the Payload Centrifuge Wheel mass so the spacecraft counter-rotates an order of magnitude more slowly than the Payload Centrifuge Wheel. This design enables the following important spacecraft operational characteristics, which significantly reduce propellant required for operations reducing overall mass and/or extending mission life:
Artificial-gravity levels of the CESs can be changed without requiring propellant to change the spacecraft total angular momentum.
The spacecraft attitude can be changed without having to compensate for gyroscopic forces of the Payload Centrifuge.

### Artificial Gravity (AG)

The spacecraft generates Centripetal Acceleration (a_{c}) by rotating the Payload Centrifuge Wheel. a_{c} is conserved due to the Law of Conservation of Angular Momentum and changes linearly with radius, but changes quadratically with RPM according to the following formula:

$${a}_{c} = \frac{{v}_{T}^{2}}{r} = \frac{{( RPM π )}^{2} r}{900}$$

where:
a_{c} (m/s²)=the artificial-gravity level at the Payload floor due to centripetal acceleration
v_{T} (m/s)=the tangential velocity at the Payload floor
r (m)=radius, the distance from the Payload floor to the axis of rotation
RPM=the Centrifuge Wheel Revolutions Per Minute=30v_{T}/πr
   An OMAGS artificial-gravity example is shown in Table 6 for Level 0 CESMs at 24.4 RPM:

$$Earth gravity = 1 g = 9 \text{.8} ( m / {s}^{2} ) = {( 24.4 π )}^{2} \times 1.5 ( m ) / 900$$

TABLE 6
OMAGS Artificial Gravity Intensity by Centrifuge Module Level

| RPM | Level 0 g | Level 1 g | Level 2 g | Level 3 g |
|---|---|---|---|---|
| 24.4 | 1.00 | 0.80 | 0.60 | 0.20 |
| 14.0 | 0.33 | 0.26 | 0.20 | 0.13 |

### OMAGS CES Payload Centrifuge

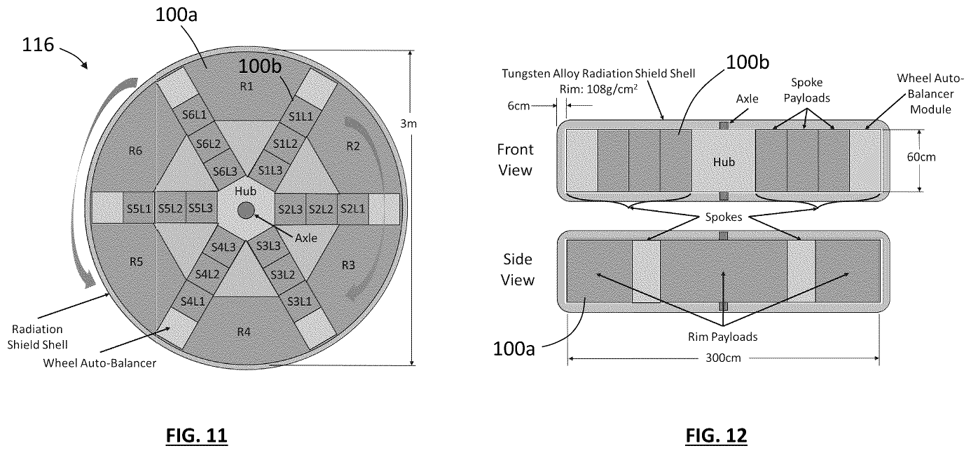

As noted in Table 6 and depicted in FIG. 11 showing an OMAGS payload centrifuge wheel CESM layout top-view, the OMAGS Centrifuge 116 simultaneously supports four artificial gravity intensities. In the Centrifuge, the lowest level 0 is at the bottom of the rim modules denoted R1 to R6, each of which can accommodate one or more CESMs. Only one rim CESM is labeled, as 100a, for clarity. Moving upwards is essentially moving toward the hub from the rim. Each Spoke can also support one or more CESMs. In the spoke, each CESM, labeled 100b, is denoted by the Spoke #(1-6) followed by the level #(1-3), i.e., (SxLy) where x=Spoke #and y=Level #.

As seen in FIGS. 11 and 12, the OMAGS Centrifuge 116 consists of:
6 Rim Payloads (R1-6)
18 Spoke Payloads (S[1-6]L[1-3])
6 Wheel Auto-Balancers
Avionics Hub
Axle
Radiation Shield Shell

In addition to the gravity level of a CESM position, the proximity between CESMs in the same CES should be considered. The CESMs of OMAGS Centrifuge 116 can be interconnected in a variety of ways to enable controlled transfer of their contents, but these connections are not shown. Adjacent CESMs can have direct connections, but CESMs that are further apart can be directly connected by piping.

In the most flexible embodiment, all the CESMS are fully connected with each other, requiring n(n−1)/2 connections where n is the number of CESMs; which in this case would require 276 direct connections since n=24. In other embodiments, far fewer connections are needed, for example with indirect connections can be used whenever possible; i.e., by permitting two CESMs in the same CES to be connected by a path that passes through one or more intermediary CESMs. Generally, the design layout should minimize the piping required.

The 6 Wheel Auto-Balancers shown in FIG. 11 are used to dynamically keep the centrifuge center of gravity at the center of its axis, since the contents of each CESM, e.g., water, animals, can move internally and may transfer between CESMs. However, this balancing can be accomplished by other means if preferable. If the centrifuge is not kept balanced, it will wobble at the RPM rate causing slosh within the CESMs and other undesirable stresses and effects.

### Payload Modules

The OMAGS spacecraft accommodates the following CES payload modules:
(6) rim 350-liter payloads at 100% nominal AG
(6) spoke 54-liter payloads at 80% nominal AG
(6) spoke 54-liter payloads at 60% nominal AG
(6) spoke 54-liter payloads at 40% nominal AG

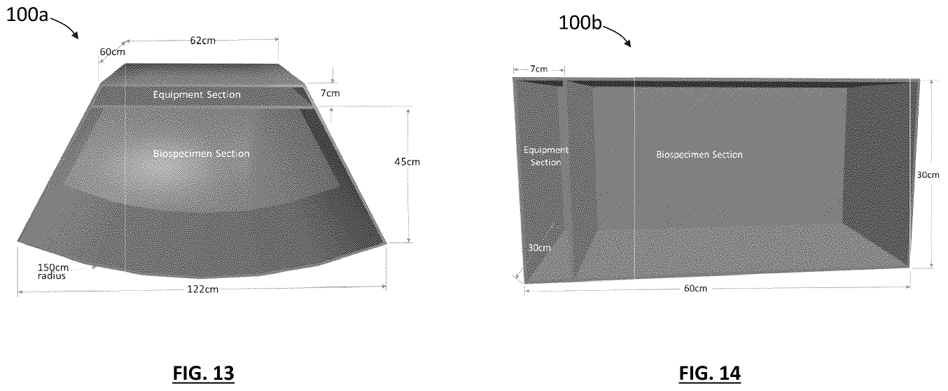

The cutaway views of the rim 100a and spoke 100b CESM modules are illustrated in FIGS. 13 and 14 respectively. All dimensions depicted are exemplary only, and other dimensions are contemplated.

### Multi-Payload Module Rationale

Although the CESMs can be connected with controlled mass flow and organism exchange between the CESMs, the following reasons support keeping CESMs independent:
Increase Experiment Robustness by increasing the system flexibility to maintain the viability of the payloads
Increase Experiment Variety by being capable of addressing multiple science questions
Increase Experiment Repeatability
Increase Experiment Biospecimen Separation
Increase Experiment Equipment Redundancy
Vary radiation shielding of otherwise identical payloads
Vary gravity level of otherwise identical payloads
Increase number of stakeholders, e.g., multiple payload science organizations

If needed, CESMs can be connected during operation as long as the connection paths have been planned for as previously discussed.

### Modular Design Approach

The long-term benefits of a modular design approach include that it scales up for much larger spacecraft centrifuges that can be incrementally assembled, repaired, and upgraded in space; along with operating both ground analogue module counterparts and their space-rated versions on Earth prior to their deployment in space.

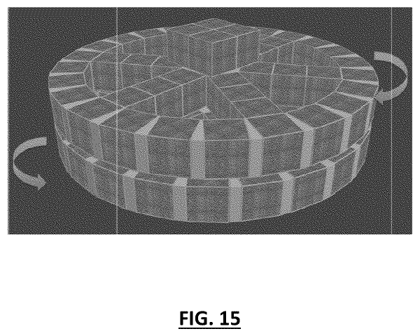

Conversely, smaller, low-cost versions of OMAGS spacecraft can be produced, such as by using 1-liter module-sized CubeSats covered by solar cells as shown in FIG. 15 where each module is a 10×10×10 cm cube.

This design is 1 m in diameter and the payload is two counter-rotating rings, each comprised of 42 CubeSats for a total payload capacity of 84 liters. The above design has very little radiation shielding and would have a relatively short mission life in LEO. Its primary value is as a testbed and for educational purposes.

In tandem, the CCEDS and OMAGS systems can be used to foster gravitational ecosystem research for developing sustainable communities in space and on Earth.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A controlled closed-ecosystem development system (CCEDS) comprising:
one or more a closed ecological systems (CESs) each having one or more controlled ecosystem modules (CESMs), each CESM comprising:
a biome containing at least one organism, and
equipment comprising one or more of sensors, actuators, or components that are associated with the biome; and
a controller for operating the equipment to effect transfer of material among CESMs to optimize one or more of organism variety, size, population, capacity, or sustainability of a biome of at least one CESM.

2. The CCEDS of claim 1, wherein the controller comprises an optimizing and planning executive (OPE) operating in conjunction with one or more control system elements selected from:
one or more pattern recognition processors,
a cloud data repository,
a CES model library, and
one or more CES simulators.

3. The CCEDS of claim 1, wherein the controller uses Evolutionary Computation (EC) to perform said optimization.

4. The CCEDS of claim 3, wherein the EC is based on patterns recognized by one or more pattern recognition processors.

5. The CCEDS of claim 3, wherein the EC is based on performance of the following steps:
1) generating a limited population of candidate models,
2) reproducing the generated with deviations,
3) determining the fitness of each population member,
4) removing or making less likely to reproduce least desirable members, and
5) returning to step 2 until exit criteria are met.

6. The CCEDS of claim 3, wherein the EC is performed at one or more levels selected from CESM parametric level, intra-CESM symbolic level, inter-CESM exchange level, inter-CES communication level, and CCEDS EC algorithm level.

7. The CCEDS of claim 3, wherein at least a first one of the one or more CESs is disposed in an orbiting modular artificial-gravity spacecraft (OMAGS).

8. The CCEDS of claim 7, wherein at least two CESMs of the first CES are subject to different gravity conditions from one another.

9. The CCEDS of claim 1, wherein the CESMs are each classified by environmental, biota, climate-temperature, climate-precipitation, gravity, and production types, and wherein:
environmental type is configured as one of: aquarium, terrarium, coastal, or subterranean,
biota type is configured as one of: microbiome, botanical garden, insectarium, amphibian zoo, reptilian zoo, aviary, aquatic biota, or mammalian zoo,
climate-temperature type is configured as one of: arctic, temperate, or tropical climate-precipitation type comprise: dry, moderate, or heavy,
gravity type is configured as one of: micro, lunar, Martian, earth, or hyper, and
production type is configured as one of: oxygen producer, carbon dioxide producer, vegetation producer, meat producer, fertilizer producer, pollinator producer, mineral producer, or universal producer.

10. A method for implementing a controlled closed-ecosystem development system (CCEDS) comprising:
establishing one or more closed ecological systems (CESs) each having one or more controlled ecosystem modules (CESMs), each CESM comprising:
a biome containing at least one organism, and
equipment comprising one or more of sensors, actuators, or components that are associated with the biome; and
effecting transfer, by a controller of each of the CESMs, of material among CESMs, wherein said transfer optimizes one or more of organism variety, size, population, capacity, or sustainability of a biome of at least one CESM,
wherein said optimization is performed at one or more levels selected from intra-CESM symbolic level, inter-CESM exchange level, inter-CES communication level, and CCEDS evolutionary computation (EC) algorithm level.

11. The method of claim 10, further comprising using evolutionary computation (EC) to effect said optimization.

12. The method of claim 11, wherein the EC is based on patterns recognized by one or more pattern recognition processors.

13. The method of claim 11, wherein the EC effects the steps of:
generating a limited population of candidate models,
reproducing the generated with deviations,
determining the fitness of each population member,
removing least desirable members or making said least desirable members less likely to reproduce, and
returning to the step of reproducing, and repeating the determining, the removing or the making, and the returning steps until exit criteria are met.

14. (canceled)

15. The method of claim 10, wherein the CESMs are each classified by environmental, biota, climate-temperature, climate-precipitation, gravity, and production types, and wherein:
environmental type is configured as one of: aquarium, terrarium, coastal, or subterranean,
biota type is configured as one of: microbiome, botanical garden, insectarium, amphibian zoo, reptilian zoo, aviary, aquatic biota, or mammalian zoo,
climate-temperature type is configured as one of: arctic, temperate, or tropical climate-precipitation type comprise: dry, moderate, or heavy,
gravity type is configured as one of: micro, lunar, Martian, earth, or hyper, and
production type is configured as one of: oxygen producer, carbon dioxide producer, vegetation producer, meat producer, fertilizer producer, pollinator producer, mineral producer, or universal producer.

16. The method of claim 11, wherein said optimization is conducted under non-earth gravity conditions.

17. A machine-readable storage medium having stored thereon a computer program for implementing a controlled closed-ecosystem development system (CCEDS), the computer program comprising a routine of set instructions for causing the machine to perform the steps of:
establishing one or more closed ecological systems (CESs) each having one or more controlled ecosystem modules (CESMs), each CESM comprising:
a biome containing at least one organism, and
equipment comprising one or more of sensors, actuators, or components that are associated with the biome; and
effecting transfer, by a controller of each of the CESMs, of material among CESMs, wherein said transfer optimizes one or more of organism variety, size, population, capacity, or sustainability of a biome of at least one CESM,
wherein said optimization is performed at one or more levels selected from intra-CESM symbolic level, inter-CESM exchange level, inter-CES communication level, and CCEDS evolutionary computation (EC) algorithm level.

18. The machine-readable storage medium of claim 17, the set of instructions further causing the machine to perform the steps of:
using evolutionary computation (EC) to effect said optimization.

19. The machine-readable storage medium of claim 18, wherein the EC is based on patterns recognized by one or more pattern recognition processors.

20. (canceled)

21. The machine-readable storage medium of claim 18, wherein said optimization is conducted under non-earth gravity conditions.
